(19) United States
(12) Patent Application Publication
(10) Pub. No.: US 2012/0288661 A1
(43) Pub. Date: Nov. 15, 2012

(54) SOLID STRUCTURE GLASS AND METHOD FOR MAKING THE SAME

(75) Inventor: KANG WEI, HongKong (CN)

(73) Assignee: Weis Limited, Kwun Tong (HK)

(21) Appl. No.: 13/104,973

(22) Filed: May 10, 2011

(51) Int. Cl. B32B 3/28; B32B 17/00; C03B 25/00; C03B 23/00; C03B 23/03

(52) U.S. Cl. 428/64.1; 428/174; 428/178; 428/131; 428/156; 428/187; 65/102; 65/104

(57) ABSTRACT

The present invention discloses a solid structure glass with a thin cross-sectional plane and a method for making the same. The solid structure glass includes an inner surface and an outer surface each combined of a curved surface, or at least two curved surfaces, or a curved surface and at least one flat surface, or at least two flat surfaces. As a result, the solid structure glass can easily be made with different shapes so as to be especially compatible with the form factor of products. Besides, the solid structure glass is made by heating a glass preform and a mold together into a forming temperature of the glass preform under condition that the glass preform is in a softened state.

### BACKGROUND OF THE INVENTION

1. Field of the Invention

The present invention relates to solid structure glasses and a method for making the same, and more particularly, to solid structure glasses which are easy to be made with different shapes and a method for making the same benefiting cost-effective manufacturing process.

2. Description of Related Art

A heat bending glass is produced by heating a glass plate into its softened state and allowing it bending to form non-flat surfaces via kinds of special molds. Such conventional heat bending glass is normally used as a windshield window of a vehicle or as a curved glass of architecture. The glass plate requires reasonable weight when it is heated up to its forming temperature. Usually, the thickness of the glass plate is within the range of 5 mm to 19 mm, and the heat bending glass is downwardly deformed by its own weight, or under the assistants of air pressure or mechanism. Ordinarily, the minimum curvature radius of the conventional heat bending glass is almost 1000 mm. However, it is difficult to manage the dimension and the curvature of the heat bending glass using the conventional heat bending procedure.

Products, such as an outer shell of an automobile light or a glass basin used in the kitchen, with curved glasses are manufactured by another method known as a cast-forming process. During such process, the liquid glass with high temperature is infused into a mold under normal pressure, and the products with the same shape of the mold can be acquired after the aggregation and solidification of the liquid glass. However, under such cast-forming process, the curved glass needs reasonable weight, the surface of the curved glass is rough, and air bubbles normally occur inside the curved glass.

Blown glasses, such glass crafts, with curved surfaces are manufactured by another conventional process. During such process, the glass is firstly melt into liquid under high temperature, and then the liquid glass is blown by special tubes. However, under such process, the curved glass needs reasonable weight and it is difficult to control the dimension and the curvature of the curved glass. Besides, the surface of the curved glass is rough and air bubbles normally occur inside the curved glass.

However, cover glasses of display equipments, or outer shells of products, or cover plates of touch devices, or function buttons, or touch panels etc. usually use flat glasses which have no solid structure.

Solid structure glasses manufactured by mechanical processes normally include a recessed top surface and a flat bottom surface. The top surface includes a central flat surface and marginal curved surfaces. However, such manufacture process is complex and it is difficult to fabricate curved glasses with complex configurations.

The thermal molding manufacture process is applied for making the curved glasses such as optical lens. However, it is only suitable for making the optical lens with simple configurations and axial symmetric figures.

Hence, an improved solid structure glass and method for making the same are needed to solve the above problems.

### BRIEF SUMMARY OF THE INVENTION

The present invention provides a solid structure glass with a thin cross-sectional plane and a method for making the same. The solid structure glass includes an inner surface and an outer surface each combined of a curved surface, or at least two curved surfaces, or a curved surface and at least one flat surface, or at least two flat surfaces. As a result, the solid structure glass can easily be made with different shapes so as to be especially compatible with the form factor of products. Besides, the solid structure glass is made by heating a glass preform and a mold together into a forming temperature of the glass preform under condition that the glass preform is in a softened state.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1(a) is a perspective view of a solid structure glass in accordance with a first embodiment of the present invention;

FIG. 1(b) is a schematic cross-sectional view of the solid structure glass taken along a plane 1A of FIG. 1(a);

FIG. 2 is a schematic cross-sectional view of a solid structure glass in accordance with a second embodiment of the present invention;

FIG. 3 is a schematic cross-sectional view of a solid structure glass in accordance with a third embodiment of the present invention;

FIG. 4 is a schematic cross-sectional view of a solid structure glass in accordance with a fourth embodiment of the present invention;

FIG. 5 is a schematic cross-sectional view of a solid structure glass in accordance with a fifth embodiment of the present invention;

FIG. 6 is a schematic cross-sectional view of a solid structure glass in accordance with a sixth embodiment of the present invention;

FIG. 7 is a schematic cross-sectional view of a solid structure glass in accordance with a seventh embodiment of the present invention;

FIG. 8(a) is a schematic cross-sectional view of a solid structure glass in accordance with an eighth embodiment of the present invention;

FIG. 8(b) is a schematic cross-sectional view of a solid structure glass similar as shown in FIG. 8(a);

FIG. 9(a) is a schematic cross-sectional view of a solid structure glass in accordance with a ninth embodiment of the present invention;

FIG. 9(b) is a schematic cross-sectional view of a solid structure glass similar as shown in FIG. 9(a);

FIG. 10(a) is a perspective view of a solid structure glass in accordance with a tenth embodiment of the present invention;

FIG. 10(b) is a top view of the solid structure glass as shown in FIG. 10(a);

FIG. 11(a) is a perspective view of a solid structure glass in accordance with an eleventh embodiment of the present invention;

FIG. 11(b) is a top view of the solid structure glass as shown in FIG. 11(a);

FIG. 12(a) is a perspective view of a solid structure glass in accordance with a twelfth embodiment of the present invention;

FIG. 12(b) is a top view of the solid structure glass as shown in FIG. 12(a);

FIG. 13(a) is a perspective view of a solid structure glass in accordance with a thirteenth embodiment of the present invention;

FIG. 13(b) is a top view of the solid structure glass as shown in FIG. 13(a);

FIG. 14(a) is a perspective view of a solid structure glass in accordance with a fourteenth embodiment of the present invention;

FIG. 14(b) is a top view of the solid structure glass as shown in FIG. 14(a);

FIG. 15(a) is a perspective view of a solid structure glass in accordance with a fifteenth embodiment of the present invention;

FIG. 15(b) is a top view of the solid structure glass as shown in FIG. 15(a);

FIG. 16(a) is a perspective view of a solid structure glass in accordance with a sixteenth embodiment of the present invention;

FIG. 16(b) is a top view of the solid structure glass as shown in FIG. 16(a);

FIG. 17(a) is a perspective view of a solid structure glass in accordance with a seventeenth embodiment of the present invention;

FIG. 17(b) is a top view of the solid structure glass as shown in FIG. 17(a);

FIG. 18(a) is a perspective view of a solid structure glass in accordance with an eighteenth embodiment of the present invention;

FIG. 18(b) is a top view of the solid structure glass as shown in FIG. 18(a);

FIG. 19(a) is a perspective view of a solid structure glass in accordance with a nineteenth embodiment of the present invention;

FIG. 19(b) is a top view of the solid structure glass as shown in FIG. 19(a);

FIG. 20(a) is a perspective view of a solid structure glass in accordance with a twentieth embodiment of the present invention;

FIG. 20(b) is a schematic cross-sectional view of the solid structure glass as shown in FIG. 20(a);

FIG. 21(a) is a perspective view of a solid structure glass in accordance with a twenty first embodiment of the present invention;

FIG. 21(b) is a schematic cross-sectional view of the solid structure glass as shown in FIG. 21(a);

FIG. 22(a) is a perspective view of a solid structure glass in accordance with a twenty second embodiment of the present invention;

FIG. 22(b) is a schematic cross-sectional view of the solid structure glass as shown in FIG. 22(a);

FIG. 22(c) is a perspective view of a solid structure glass similar as shown in FIG. 22(a);

FIG. 23(a) is a perspective view of a solid structure glass in accordance with a twenty third embodiment of the present invention;

FIG. 23(b) is another perspective view of the solid structure glass as shown in FIG. 23(a);

FIG. 24(a) is a perspective view of a solid structure glass in accordance with a twenty fourth embodiment of the present invention;

FIG. 24(b) is a schematic cross-sectional view of the solid structure glass as shown in FIG. 24(a);

FIG. 24(c) is a perspective view of a solid structure glass similar as shown in FIG. 24(a);

FIG. 24(d) is a schematic cross-sectional view of the solid structure glass as shown in FIG. 24(c);

FIG. 24(e) is a perspective view of a solid structure glass similar as shown in FIG. 24(a);

FIG. 24(f) is a schematic cross-sectional view of the solid structure glass as shown in FIG. 24(e); and

FIG. 25 is a schematic manufacturing flow charts for making a solid structure glass.

### DETAILED DESCRIPTION OF THE PREFERRED EMBODIMENTS

Reference will now be made to the drawing figures to describe the embodiments of the present invention in detail. In the following description, the same drawing reference numerals are used for the same elements in different drawings.

Referring to FIGS. 1(a) and 1(b), a first embodiment of the present invention discloses a solid structure glass 1 which includes a body 101 and a bending portion 102 connecting the body 101. The body 101 includes an outer surface 112 and an inner surface 122. The bending portion 102 includes an outer surface 113 and an inner surface 123. The outer surfaces 102 and 112 are both curved surfaces. Referring to FIG. 1(b), a cross-sectional plane is of thin configuration taking along a plane 1A thereof Curvatures of the outer surfaces 113 and 123 are constant and non-zero, or are continuously variational. The continuously variational curvatures of the outer surfaces 113 and 123 are linear or non-linear. It is understood that the non-linearly continuously variational curvatures represent free curved surfaces. From an integrated view of the first embodiment of the present invention, both the outer surface 110 and the inner surface 120 of the solid structure glass 1 are combined of a flat surface and a curved surface so that the solid structure glass 1 is especially compatible with the form factor of products.

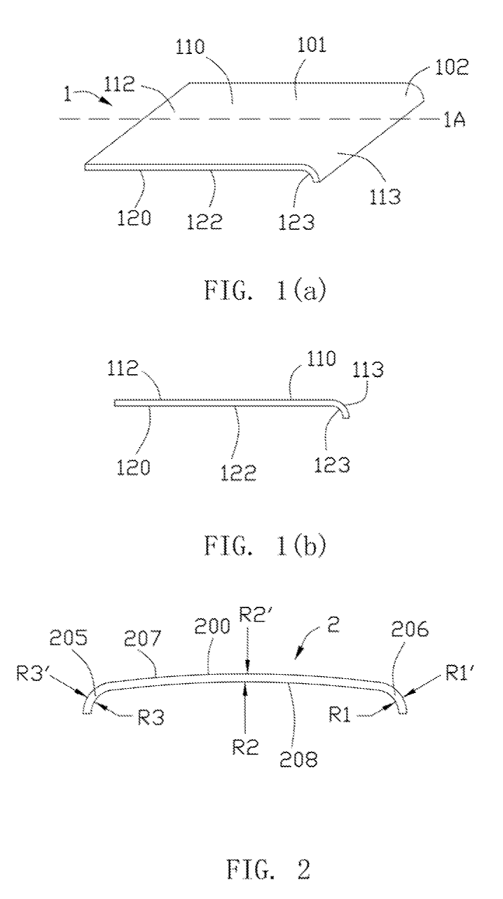

Referring to FIG. 2, a second embodiment of the present invention discloses a solid structure glass 2 which includes a body 200 and first and second bending portions 205 and 206 extending from peripheral sides of the body 200, respectively. The first and the second bending portions 205 and 206 are integrally connected with the body 200. The solid structure glass 2 includes an outer surface 207 and an inner surface 208 wherein the outer surface 207 and the inner surface 208 each is combined of three curved surfaces. A cross-sectional plane of the solid structure glass 2 is of thin configuration. Curvatures of the outer surface 207 and the inner surface 208 are constant and non-zero, or are continuously variational. The continuously variational curvatures are linear or non-linear. It is understood that the non-linearly continuously variational curvatures represent free curved surfaces. In detail, the curvatures of the outer surface and the inner surface of the body 200 are designated by R2′ and R2, respectively. The curvatures of the outer surface and the inner surface of the first bending portion 205 are designated by R3′ and R3, respectively. The curvatures of the outer surface and the inner surface of the second bending portion 206 are designated by R1′ and R1, respectively. From the cross-sectional plane thereof, the outer surface 207 of the solid structure glass 2 is combined of three non-zero curvatures R1′, R2′, R3′, respectively. The inner surface 208 of the solid structure glass 2 is combined of three non-zero curvatures R1, R2, R3, respectively. The curvatures R1, R2, R3, R1′, R2′, R3′ can be the same or different. It is easy to understand that the solid structure glass 2 can be modified to make the body 200 connecting with more than two bending portions.

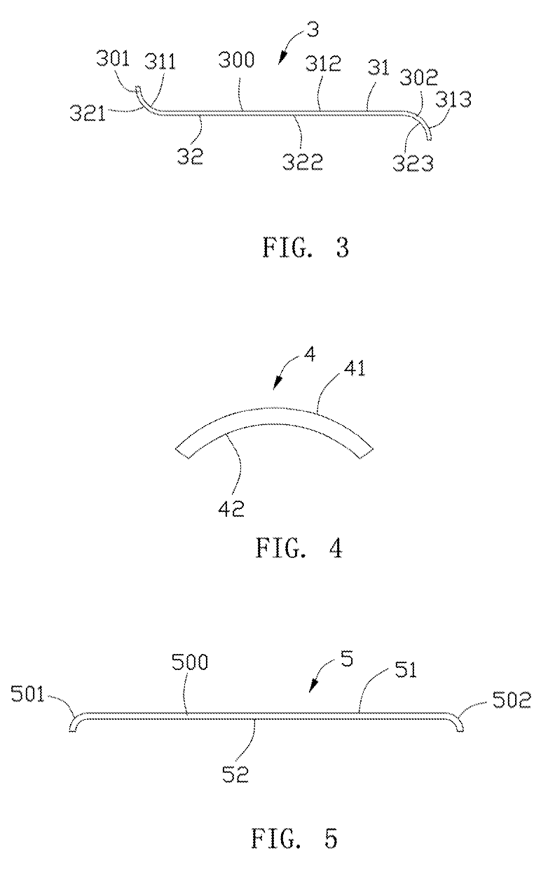

Referring to FIG. 3, a third embodiment of the present invention discloses a solid structure glass 3 which includes a body 300 and first and second bending portions 301 and 302 extending from lateral sides of the body 300. The first and the second bending portions 301 and 302 are integrally connected with the body 300. The body 300 includes a first outer surface 312 and a first inner surface 322. The first bending portion 301 includes a second outer surface 311 and a second inner surface 321. The second bending portion 302 includes a third outer surface 313 and a third inner surface 323. The first outer surface 312 and the first inner surface 322 are both flat surfaces, while the second and third outer surfaces 311, 313 and the second and the third inner surfaces 321, 323 are all curved surfaces. A cross-sectional plane of the solid structure glass 3 is of thin configuration. Curvatures of the first and the second bending portions 301 and 302 are constant and non-zero, or are continuously variational. The continuously variational curvatures are linear or non-linear. It is understood that the non-linearly continuously variational curvatures represent free curved surfaces. From an integrated view of the third embodiment of the present invention, an outer surface 31 of the solid structure glass 3 are combined of the first, the second and the third outer surfaces 312, 311 and 313, and an inner surface 32 of the solid structure glass 3 are combined of the first, the second and the third inner surfaces 322, 321 and 323. That is to say, both the outer surface 31 and the inner surface 32 are combined of a flat surface and a curved surface. From the cross-sectional plane of the solid structure glass 3, the curvatures of the second outer surface 311 and the second inner surface 321 are positive, while the curvatures of the third outer surface 313 and the third inner surface 323 are negative.

Referring to FIG. 4, a fourth embodiment of the present invention discloses a solid structure glass 4 which is similar to the solid structure glass 2 of the second embodiment. The solid structure glass 4 includes a curved outer surface 41 and a curved inner surface 42. A cross-sectional plane of the solid structure glass 4 is of thin configuration. Curvatures of the outer surface 41 and the inner surface 42 are constant and non-zero, or are continuously variational. The continuously variational curvatures are linear or non-linear. It is understood that the non-linearly continuously variational curvatures represent free curved surfaces.

Referring to FIG. 5, a fifth embodiment of the present invention discloses a solid structure glass 5 which is similar to the solid structure glass 2 of the second embodiment. The solid structure glass 5 includes a body 500 and first and second bending portions 501 and 502 connecting the body 500. The only difference between the solid structure glasses 5 and 2 is that the outer and the inner surfaces of the body 500 are flat surfaces while the outer and the inner surfaces of the body 200 are curved surfaces. Accordingly, the outer and the inner surfaces 51 and 52 of the solid structure glass 5 are both combined of a flat surface and two curved surfaces.

Referring to FIG. 6, a sixth embodiment of the present invention discloses a solid structure glass 6 which is similar to the solid structure glass 2 of the second embodiment. The solid structure glass 6 includes a body 600 and first and second slant portions 601 and 602 connecting the body 600. The outer and the inner surfaces of all the body 600 and the first and the second slant portion 601 and 602 are flat surfaces. From a cross-sectional plane thereof, the solid structure glass 6 includes an outer surface 61 and an inner surface 62 both combined of three flat surfaces. Joint sections 63, 64 of the adjacent flat planes form an angle within the range of 0 degree to 180 degrees. However, the outer and the inner surfaces 61, 62 of the solid structure glass 6 can be combined of a curved surface and two flat surfaces, alternatively.

Referring to FIG. 7, a seventh embodiment of the present invention discloses a solid structure glass 7 which is similar to the solid structure glass 6 of the sixth embodiment. The solid structure glass 7 includes a body 700 and a slant portion 701 connecting the body 700. The only difference between the solid structure glasses 7 and 6 is that the first slant portion 601 is omitted in the solid structure glass 7. Similarly, the outer and the inner surfaces of the solid structure glass 7 can be combined of a curved surface and a flat surface.

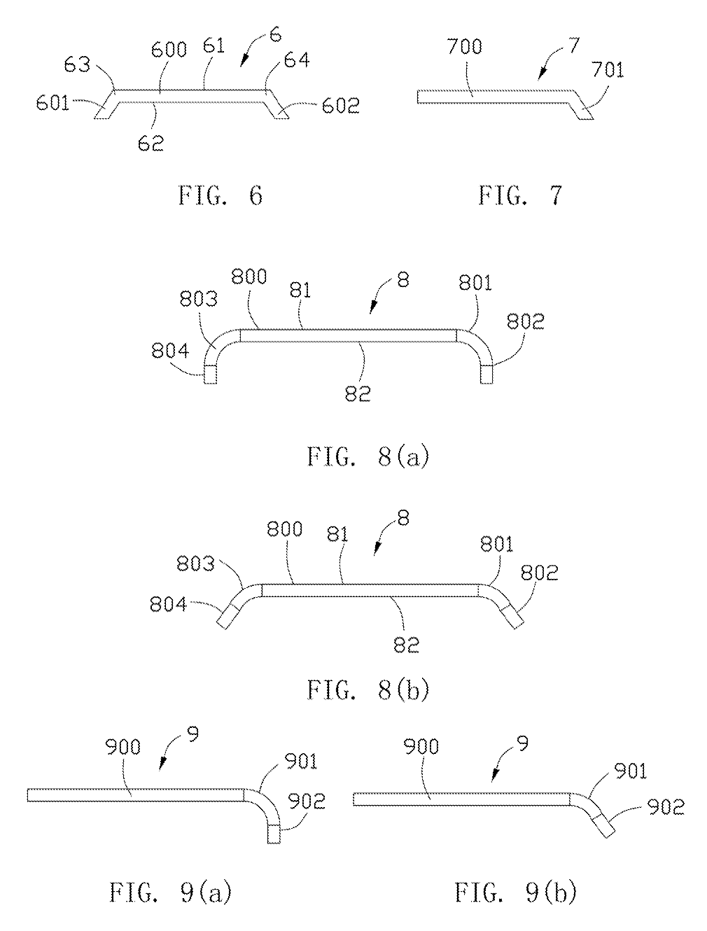

Referring to FIG. 8(a), an eighth embodiment of the present invention discloses a solid structure glass 8 including a body 800, a first bending portion 801 connecting the body 800, a first extending portion 802 extending from the first bending portion 801, a second bending portion 803 connecting the body 800, and a second extending portion 804 extending from the second bending portion 803. Both inner and outer surfaces of the body 800, the first extending portion 802 and the second extending portion 804 are flat surfaces. The inner and outer surfaces of the first and the second bending portions 801 and 803 are curved surfaces. The first and the second extending portions 802 and 804 are perpendicular to the body 800. From a cross-sectional plane thereof, the solid structure glass 8 includes an outer surface 81 and an inner surface 82 both combined of a plurality of alternate curved surfaces and flat surfaces.

Referring to FIG. 8(b), the first and the second extending portions 803 and 804 can be set not be perpendicular to the body 800. Under this condition, an angle is formed therebetween within the range of 0 degree and 180 degrees except 90 degrees.

Referring to FIG. 9(a), a ninth embodiment of the present invention discloses a solid structure glass 9 including a body 900, a first bending portion 901 connecting the body 900, and a first extending portion 902 extending from the first bending portion 901. The first extending portion 902 is perpendicular to the body 900. The solid structure glass 9 is similar to the solid structure glass 8 of the eighth embodiment, and the only difference between them is that the second bending portion 803 and the second extending portion 804 are omitted in the solid structure glass 9.

Referring to FIG. 9(b), the solid structure glass 9 can be modified to similar to FIG. 8(b) while omits the second bending portion 803 and the second extending portion 804.

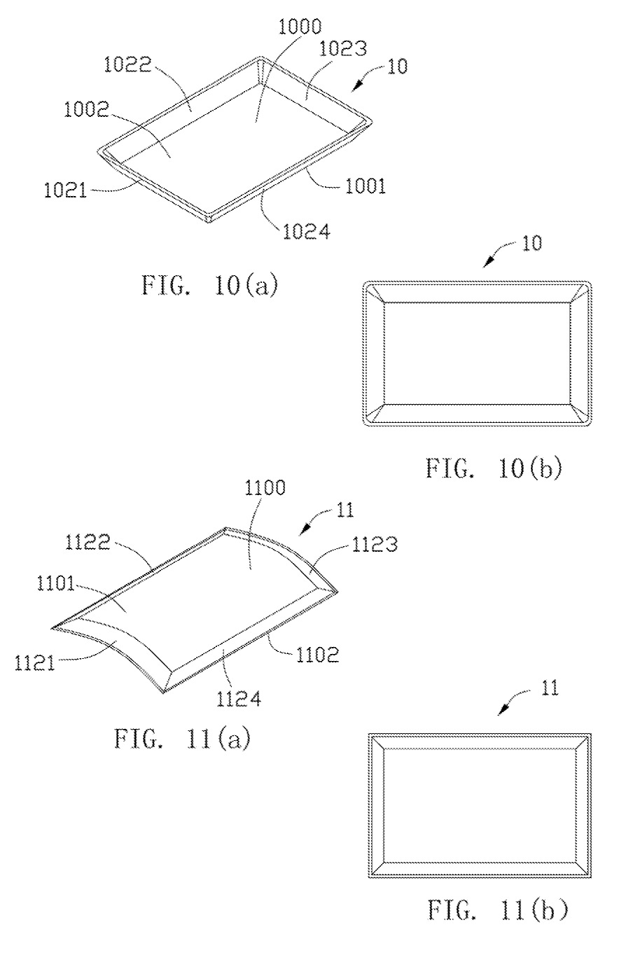

Referring to FIGS. 10(a) and 10(b), an tenth embodiment of the present invention discloses a solid structure glass 10 including a rectangular body 1000 and four extending portions 1021, 1022, 1023, 1024 extending from peripheral sides of the body 1000. The body 1000 is flat shaped and the extending portions 1021, 1022, 1023, 1024 are curved. From an integrated view thereof, the outer surface 1001 and the inner surface 1002 are both combined of a flat surface and multiple curved surfaces. Referring to FIG. 10(b), the solid structure glass 10 is rectangular from a top view thereof A cross-sectional plane of the solid structure glass 10 is of thin configuration, among which curvatures of the curved surfaces are constant and non-zero, or are continuously variational. The continuously variational curvatures are linear or non-linear. It is understood that the non-linearly continuously variational curvatures represent free curved surfaces.

Referring to FIGS. 11(a) and 11(b), an eleventh embodiment of the present invention discloses a solid structure glass 11 including a body 1100 and four extending portions 1121, 1122, 1123, 1124 extending from peripheral sides of the body 1100. Outer and inner surfaces of the body 1100 and the extending portions 1121, 1122, 1123, 1124 are curved. From an integrated view thereof, the outer surface 1101 and the inner surface 1102 of the solid structure glass 11 are both combined of multiple curved surfaces. Referring to FIG. 11(b), the solid structure glass 11 is rectangular as well from a top view thereof. A cross-sectional plane of the solid structure glass 11 is of thin configuration, among which curvatures of the curved surfaces are constant and non-zero, or are continuously variational. The continuously variational curvatures are linear or non-linear. It is understood that the non-linearly continuously variational curvatures represent free curved surfaces.

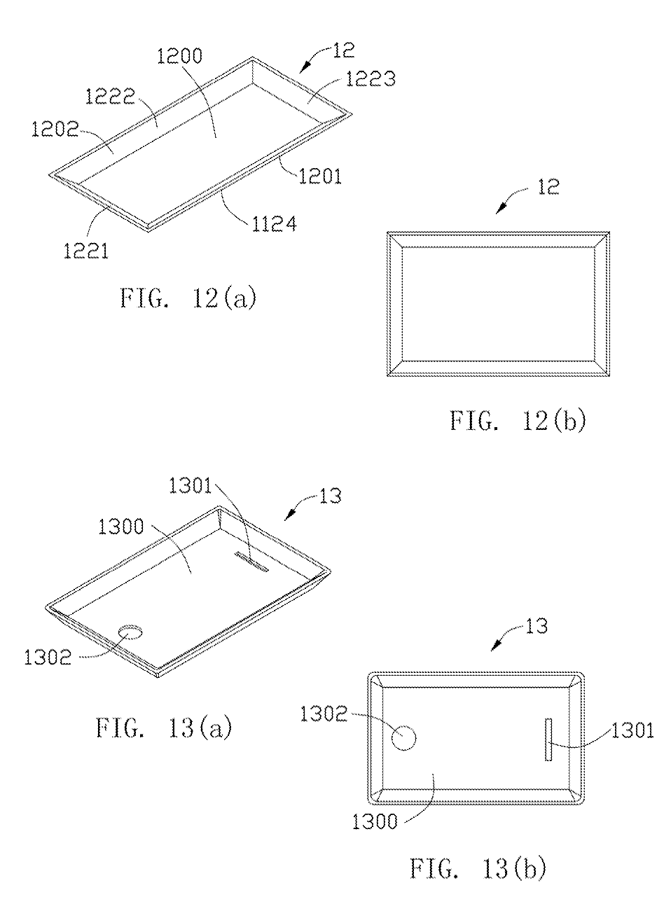

Referring to FIGS. 12(a) and 12(b), a twelfth embodiment of the present invention discloses a solid structure glass 12 including a body 1200 and four extending portions 1221, 1222, 1223, 1224 extending from peripheral sides of the body 1200. Outer and inner surfaces of the body 1200 and the extending portions 1221, 1222, 1223, 1224 are flat. Each angle formed by the body 1200 and the extending portions 1221, 1222, 1223, 1224 is within the range of 0 degree to 180 degrees. From an integrated view thereof, the outer surface 1201 and the inner surface 1202 of the solid structure glass 12 are both combined of multiple flat surfaces. Referring to FIG. 12(b), the solid structure glass 12 is rectangular as well from a top view thereof. It is easy to be understood that the outer and the inner surfaces of the body 1200 can be curved surfaces, alternatively.

Referring to FIGS. 13(a) and 13(b), a thirteenth embodiment of the present invention discloses a solid structure glass 13 similar to that of the tenth embodiment. The only difference between them is that a body 1300 of the solid structure glass 13 defines two through holes 1301 and 1302, among which the through hole 1301 is narrow and elongated, and the through hole 1302 is round. It is easy to be understood that the through holes 1301, 1302 can be other shapes, alternatively.

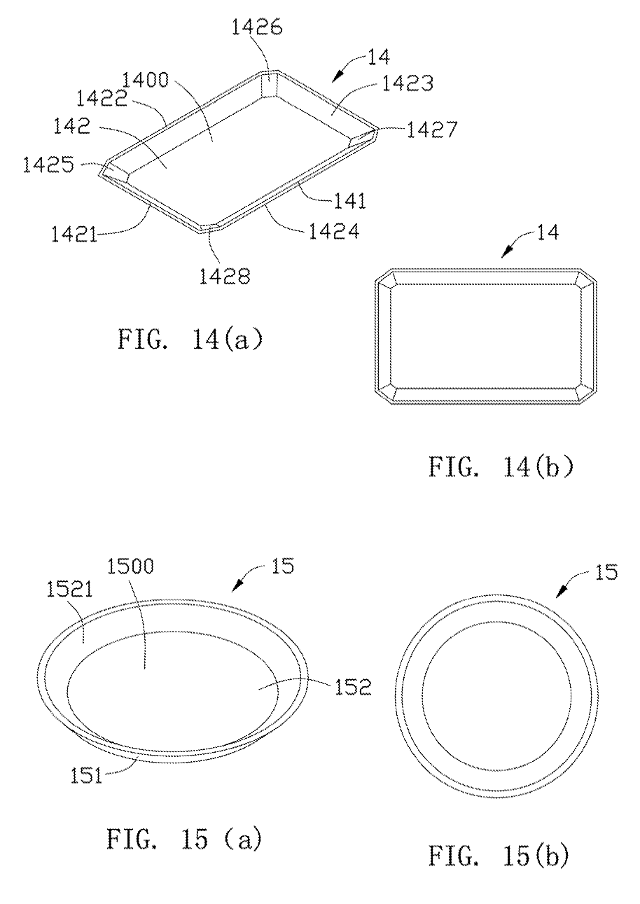

Referring to FIGS. 14(a) and 14(b), a fourteenth embodiment of the present invention discloses a solid structure glass 14 including a polygonal body 1400 and eight extending portions 1421, 1422, 1423, 1424, 1425, 1426, 1427, 1428 extending from peripheral sides of the body 1400. Outer and inner surfaces of the body 1400 are flat surfaces, while the eight extending portions 1421 to 1428 are curved. From an integrated view thereof, the outer surface 141 and the inner surface 142 of the solid structure glass 14 are both combined of multiple curved surfaces. Referring to FIG. 14(b), the solid structure glass 14 is polygonal from a top view thereof. A cross-sectional plane of the solid structure glass 14 is of thin configuration. Curvatures of the curved surfaces are constant and non-zero, or are continuously variational. The continuously variational curvatures are linear or non-linear. It is easy to be understood that the eight extending portions 1421 to 1428 can be flat, alternatively.

Referring to FIGS. 15(a) and 15(b), a fifteenth embodiment of the present invention discloses a solid structure glass 15 including a body 1500 and a torus extending section 1521 extending from peripheral sides of the body 1500. The torus extending section 1521 can be recognized as multiple extending portions linked together. Outer and inner surfaces of the body 1500 are flat surfaces or curved surfaces. Outer and inner surfaces of the extending section 1521 are curved surfaces. From an integrated view thereof, a cross-sectional plane of the solid structure glass 15 is of thin configuration. Curvatures of the curved surfaces are constant and non-zero, or are continuously variational. The continuously variational curvatures are linear or non-linear. Referring to FIG. 15(b), the solid structure glass 15 is round from a top view thereof.

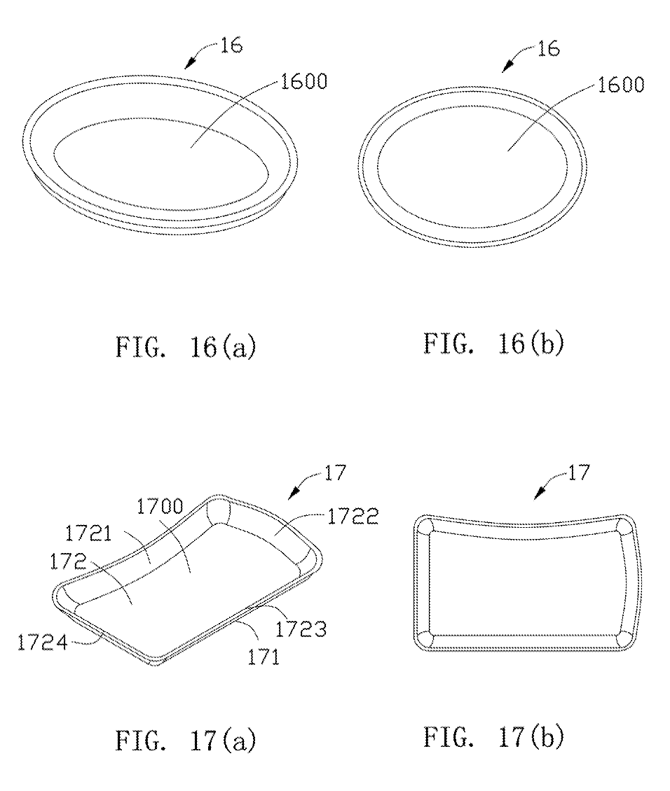

Referring to FIGS. 16(a) and 16(b), a sixteenth embodiment of the present invention discloses a solid structure glass 16 similar to that of the fifteenth embodiment. The only difference between them is that a body 1600 of the solid structure glass 16 is elliptic while body 1500 of the solid structure glass 15 is round. Referring to FIG. 16(b), the solid structure glass 16 is elliptic from a top view thereof Ellipse means that the locus of points for which the sum of the distances from each point to two fixed points is equal. It is easy to understand that the geometric figures of the solid structure glass 16 from a top view can be of sector or arc. Sector means the portion of a circle bounded by two radii and the included arc. The arc means a segment of a circle.

Referring to FIGS. 17(a) and 17(b), a seventeenth embodiment of the present invention discloses a solid structure glass 17 including a body 1700 and four extending portions 1721, 1722, 1723, 1724 integrally extending from peripheral sides of the body 1700. Outer and inner surfaces of the body 1700 are flat surfaces or curved surfaces. Outer and inner surfaces of the extending portions 1721, 1722, 1723, 1724 are curved surfaces. From an integrated view thereof, the outer surface 171 and the inner surface 172 of the solid structure glass 17 are both combined of multiple curved surfaces and a flat surface, or all curved surfaces. Referring to FIG. 17(b), the solid structure glass 17 is unsymmetrical from a top view thereof, so that the solid structure glass 17 is especially compatible with the form factor of products.

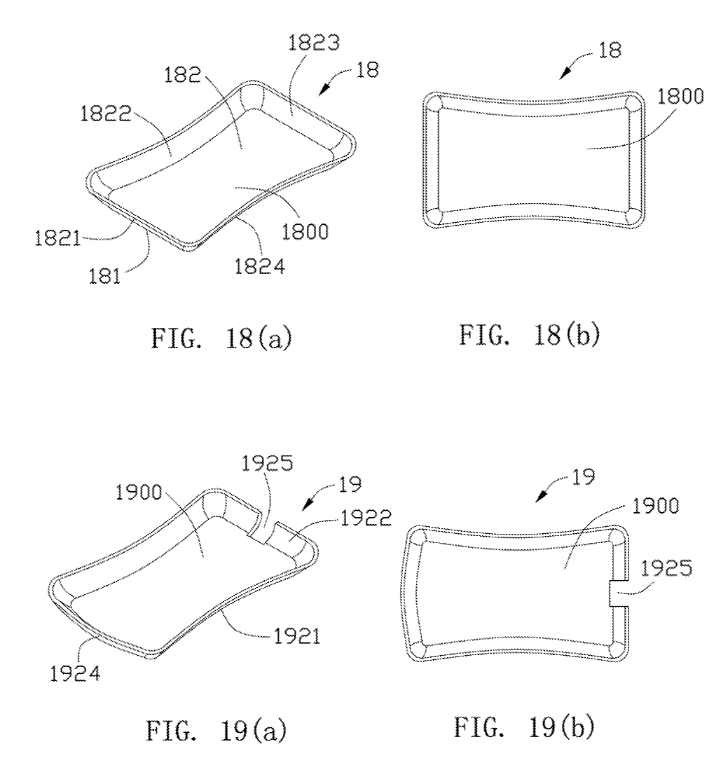

Referring to FIGS. 18(a) and 18(b), an eighteenth embodiment of the present invention discloses a solid structure glass 18 including a body 1800 and four extending portions 1821, 1822, 1823, 1824 integrally extending from peripheral sides of the body 1800. Outer and inner surfaces of the body 1800 are flat surfaces or curved surfaces. Outer and inner surfaces of the extending portions 1821, 1822, 1823, 1824 are curved surfaces. Referring to FIG. 18(b), the solid structure glass 18 is symmetrical from a top view thereof.

Referring to FIGS. 19(a) and 19(b), a nineteenth embodiment of the present invention discloses a solid structure glass 19 including a body 1900 and four extending portions 1921, 1922, 1923, 1924 integrally extending from peripheral sides of the body 1900. The solid structure glass 19 is similar to that of the eighteenth embodiment and the difference between them is that at least one of the extending portions 1921, 1922, 1923, 1924 defines a cutout 1925 so that the extending portions 1921, 1922, 1923, 1924 are erose.

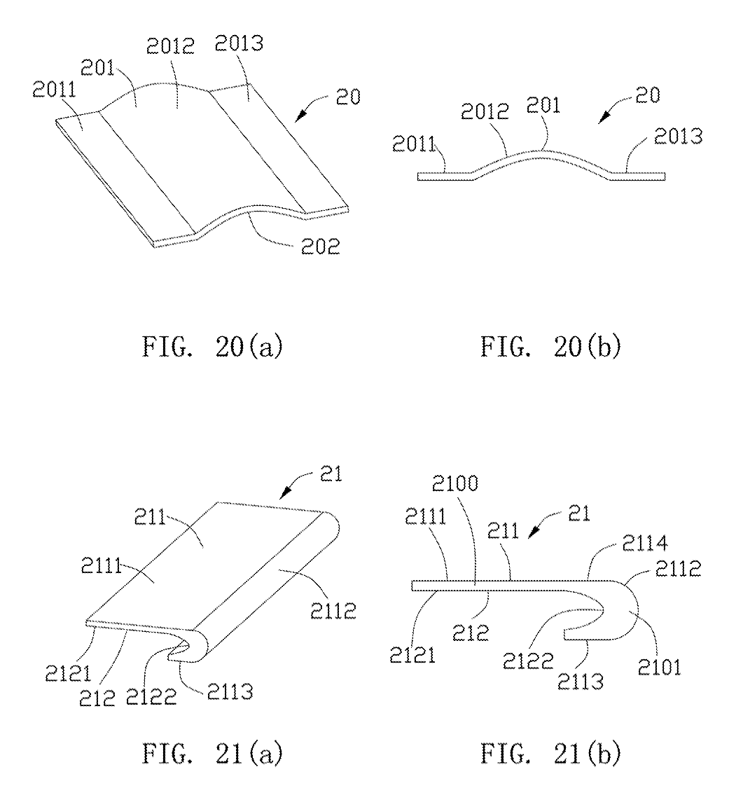

Referring to FIGS. 20(a) and 20(b), a twentieth embodiment of the present invention discloses a solid structure glass 20 including a body 2012 and first and second extending portions 2011 and 2013 integrally extending from the body 2012. Outer and inner surfaces of the body 2012 are curved surfaces. Outer and inner surfaces of the first and the second extending portions 2011, 2013 are flat surfaces. A cross-sectional plane of the solid structure glass 20 is of thin configuration. Curvatures of the curved surfaces are constant and non-zero, or are continuously variational. The continuously variational curvatures are linear or non-linear. From an integrated view of the twentieth embodiment of the present invention, both the outer surface 201 and the inner surface 202 of the solid structure glass 20 are combined of a curved surface and two flat surfaces.

Referring to FIGS. 21(a) and 21(b), a twenty first embodiment of the present invention discloses a solid structure glass 21 including a body 2100 and an extending portion 2101 integrally extending from the body 2100. A cross-sectional plane of the solid structure glass 21 is of thin configuration wherein outer and inner surfaces 2111 and 2121 of the body 2100 are flat surfaces. An outer surface of the extending portion 2101 includes a first flat surface 2114, a second flat surface 2113 opposite to the first flat surface 2114, and a first curved surface 2112 connecting the first and the second flat surfaces 2114, 2113. An inner surface of the extending portion 2101 is a second curved surface 2122 and located at the inner side of the first curved surface 2112. Referring to FIG. 21(b), from a cross-section plane thereof, peripheral sides of the solid structure glass 21 includes an outer surface 211 and an inner surface 212. The outer surface 211 is combined of the outer surface 2111, the first curved surface 2112 and the second flat surface 2113. The inner surface 212 is combined of the inner surface 2121 and the second curved surface 2122. That is to say, the outer surface 211 is combined of two flat surfaces and a curved surface, and the inner surface 212 is combined of a flat surface and a curved surface. The outer surface 2111 is coplanar with the first flat surface 2114. Curvatures of the curved surfaces are constant and non-zero, or are continuously variational. The continuously variational curvatures are linear or non-linear. However, the outer surface 2111 and the inner surface 2121 can be curved surfaces, alternatively.

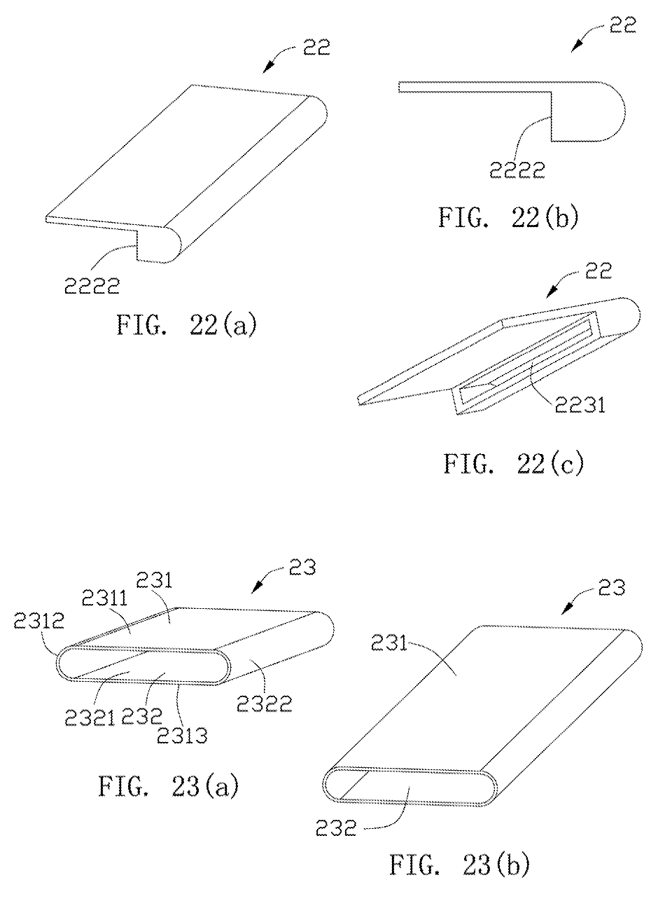

Referring to FIGS. 22(a) and 22(b), a twenty second embodiment of the present invention discloses a solid structure glass 22 similar to the solid structure glass 21. The only difference between them is that the second curved surface 2122 is replaced by a second flat surface 2222 so that the area is of solid configuration.

Referring to FIGS. 22(c), the peripheral side of the solid structure glass 22 can be formed with a slot 2231 recessed from the second flat surface 2222 so that the area is of slot configuration.

Referring to FIGS. 23(a) and 23(b), a twenty third embodiment of the present invention discloses an annulus solid structure glass 23 including a pair of opposite bodies 2311, 2321 and a pair of connecting portions 2312, 2322 connecting the pair of bodies 2311, 2321 from lateral sides thereof. Outer and inner surfaces of the bodies 2311, 2321 are flat surfaces. Outer and inner surfaces of the connecting portions 2312, 2322 are curved surfaces. From a cross-sectional plane thereof, both an outer surface 231 and an inner surface 232 of the solid structure glass 23 are combined of a pair of flat surfaces and a pair of curved surfaces. Curvatures of the curved surfaces are constant and non-zero, or are continuously variational. The continuously variational curvatures are linear or non-linear.

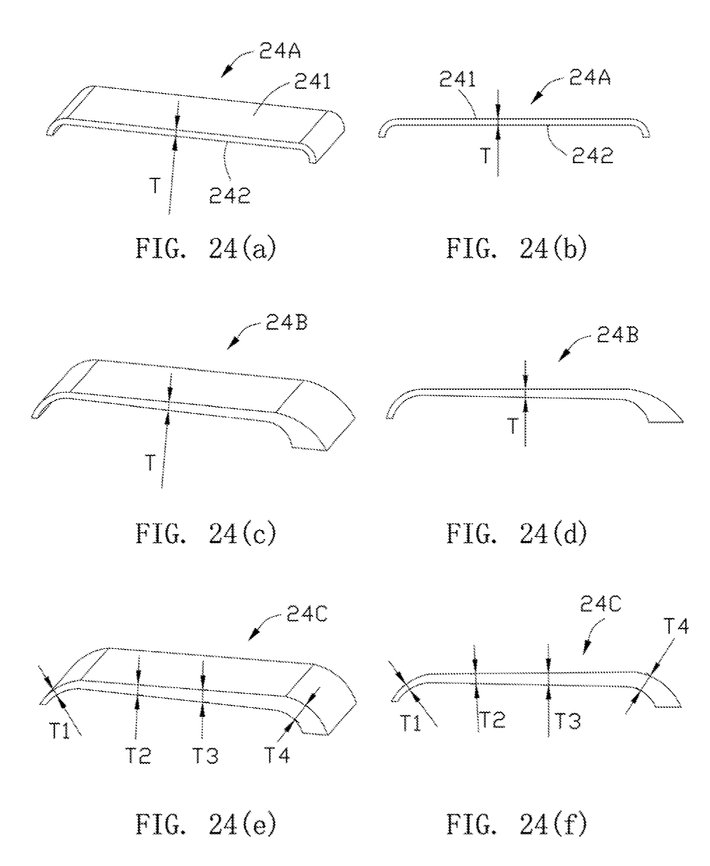

Referring to FIGS. 24(a) and 24(b), a twenty fourth embodiment of the present invention discloses a solid structure glass 24A including an outer surface 241 and an inner surface 242. A thickness T between the outer surface 241 and the inner surface 242 is consistent.

Referring to FIGS. 24(c) and 24(d), a thickness T of the solid structure glass 24B is linearly variational.

Referring to FIGS. 24(e) and 24(f), the thickness of the solid structure glass 24C includes T1, T2 and T3, and the thickness T1, T2 and T3 is non-linearly variational.

It is easy to be understood that the changes of the thickness of the solid structure glasses 24A to 24C can be applied to all the above-described embodiments. According to special designs, the thickness of at least part of the solid structure glass can be enforced so as to reinforce the structure of the solid structure glass.

According to the embodiments of the present invention, thickness of the above-mentioned solid structure glasses is within the range of 0 1 mm to 10 mm. However, curvatures of the above-mentioned solid structure glasses can be of any numerical value. That is to say, the curvatures of the above-mentioned solid structure glasses are not restricted and solid structure glasses can be free curved surfaces. The shapes of the solid structure glasses can be different and the manufacturing precision of the solid structure glasses can be easily managed. As a result, the solid structure glasses are especially compatible with the form factor of products.

For improvements of the present invention, the outer surface and/or the inner surface of each solid structure glass can be covered by a surface film applied for anti-burst, or decoration, or anti-glare, or anti-reflection, or anti-smudge, or hardening, or touch sensing, or the combinations of the afore functions. The surface film can be a conductive film or a non-conductive film. The non-conductive film includes an anti-burst film, a decoration film, an optical film, an anti-smudge film and a hardening film. The optical film can be an anti-glare film or an anti-reflection film.

The above-mentioned solid structure glasses can be applied as cover glasses of display equipments, or outer shells of products, or appearance assemblies of electronic devices such as computer, TV box, keyboard, mouse, earphone etc., or cover plates of touch devices, or function buttons, or touch panels etc.

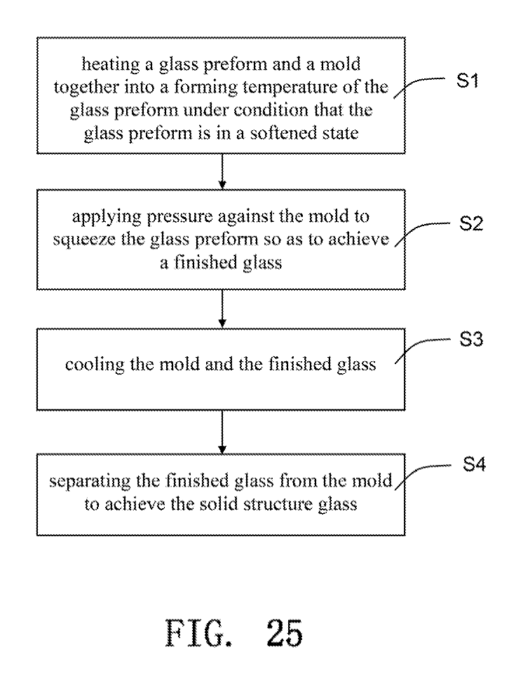

Referring to FIG. 25, a method for making the above-mentioned solid structure glasses is disclosed with the following steps:
S1, heating a glass preform and a mold together into a forming temperature of the glass preform under condition that the glass preform is in a softened state;
S2, applying pressure against the mold to squeeze the glass preform so as to achieve a finished glass;
S3, cooling the mold and the finished glass; and
S4, separating the finished glass from the mold to achieve the solid structure glass.

Besides, before the step S1, the glass preform is put into the mold. The step S3 includes an annealing procedure to eliminate thermal stress. The step S4 includes a procedure of eliminating the pressure and then the finished glass and the die can be separated. The forming temperature in the step S2 is within the range of a glass transition temperature and a glass softened temperature of the glass preform.

The solid structure glass is integral and includes a cross-sectional plane of thin configuration. Applying pressure against the mold to squeeze the glass preform in step S2 can make robust attachment of the glass preform and the mold so that the finished glass can be of precision dimension and required structure. That is to say, further aided procedure can be omitted according to the preferred embodiments of the present invention for saving costs.

It is easy to be understood that, in order to improve the capability of the solid structure glass, a step of covering the outer surface and/or the inner surface of the solid structure glass by a surface film can be recommended. The surface film can be a conductive film or a non-conductive film. The non-conductive film includes an anti-burst film, a decoration film, an optical film, an anti-smudge film and a case hardening film. The optical film can be an anti-glare film or an anti-reflection film.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. A solid structure glass with a thin cross-sectional plane, comprising:
an inner surface combined of a curved surface, or at least two curved surfaces, or a curved surface and at least one flat surface, or at least two flat surfaces; and
an outer surface combined of a curved surface, or at least two curved surfaces, or a curved surface and at least one flat surface, or at least two flat surfaces; wherein
the solid structure glass is made by heating a glass preform and a mold together into a forming temperature of the glass preform under condition that the glass preform is in a softened state.

2. The solid structure glass as claimed in claim 1, wherein a thickness of the solid structure glass between the outer surface and the inner surface is within a range of 0.1 mm to 10 mm.

3. The solid structure glass as claimed in claim 1, further comprising a body and at least one bending portion connecting the body, outer and inner surfaces of the body each being a flat surface, or a curved surface, or a combination of a flat surface and a curved surface, outer and inner surfaces of the bending portion each being a curved surface, outer and inner surfaces of the solid structure glass being a combination of a flat surface and a curved surface.

4. The solid structure glass as claimed in claim 1, further comprising a body and first and second bending portions extending from peripheral sides of the body, respectively, outer and inner surfaces of the first and the second bending portions being curved surfaces, outer and inner surfaces of the body each being a curved surface, or a flat surface, or a combination of a flat surface and a curved surface, outer and inner surfaces of the solid structure glass being comprised of at least two curved surfaces.

5. The solid structure glass as claimed in claim 1, further comprising a body and at least one slant portion integrally extending from the body, outer and inner surfaces of the slant portion being flat surfaces, an angle being formed at a connecting section of the body and the slant portion within a range of greater than 0 degree to smaller than 180 degrees.

6. The solid structure glass as claimed in claim 1, further comprising a body, at least one bending portion integrally extending from the body, and at least one extending portion extending from the bending portion, outer and inner surfaces of the body portion and the extending portion being flat surfaces, outer and inner surfaces of the bending portion being curved surfaces, an angle being formed by the body and the extending portion within a range of greater than 0 degree to smaller than 180 degrees.

7. The solid structure glass as claimed in claim 1, further comprising a body and an extending portion integrally extending from the body, an outer surface of the bending portion comprising a first flat surface, a second flat surface opposite to the first flat surface and a first curved surface connecting the first and the second flat surfaces, the outer surface of the solid structure glass being a combination of at least two flat surfaces and a curved surface.

8. The solid structure glass as claimed in claim 1, further comprising a body and a plurality of extending portions integrally extending from the body, the outer surface of the solid structure glass being comprised of an outer surface of the body and outer surfaces of the extending portions, the inner surface of the solid structure glass being comprised of an inner surface of the body and inner surfaces of the extending portions; wherein each of the outer and the inner surfaces of the body portion is a flat surface or a curved surface, while each of the outer and the inner surfaces of the extending portions is a curved surface.

9. The solid structure glass as claimed in claim 1, wherein the solid structure glass is annulus and comprises a pair of opposite bodies and a pair of connecting portions connecting the pair of bodies, outer and inner surfaces of each body being flat surfaces, outer and inner surfaces of each connecting portion being curved surfaces.

10. The solid structure glass as claimed in claim 1, wherein a top view of the solid structure glass is polygonal, or round, or elliptic, or sector, or arc, or a free configuration, or a combination thereof

11. The solid structure glass as claimed in claim 1, further comprising at least one through hole throughout the outer and the inner surface of the solid structure glass.

12. The solid structure glass as claimed in claim 1, wherein the solid structure glass can be applied as cover glasses of display equipments, or outer shells of products, or appearance assemblies of electronic devices, or cover plates of touch devices, or function buttons, or touch panels.

13. The solid structure glass as claimed in claim 1, wherein a thickness of the solid structure glass between the outer and the inner surfaces thereof is consistent, or linearly variational, or non-linearly variational.

14. The solid structure glass as claimed in claim 1, wherein the solid structure glass is covered by a surface film applied for anti-burst, or decoration, or anti-glare, or anti-reflection, or anti-smudge, or hardening, or touch sensing, or the combinations of the afore functions, the surface film being a conductive film or a non-conductive film, the non-conductive film including an anti-burst film, a decoration film, an optical film, an anti-smudge film and a hardening film, the optical film being an anti-glare film or an anti-reflection film.

15. The solid structure glass as claimed in claim 1, wherein a curvature of each curved surface is constant and non-zero, or is continuously variational, the continuously variational curvature being linear or non-linear.

16. A method for making a solid structure glass comprising the following steps:
S1, heating a glass preform and a mold together into a forming temperature of the glass preform under condition that the glass preform is in a softened state;
S2, applying pressure against the mold to squeeze the glass preform so as to achieve a finished glass;
S3, cooling the mold and the finished glass; and
S4, separating the finished glass from the mold to achieve the solid structure glass, a thickness of the solid structure glass being consistent, or linearly variational, or non-linearly variational.

17. The method as claimed in claim 16, wherein before the step S1, the glass preform is put into the mold, the forming temperature in the step S2 being within a range of a glass transition temperature and a glass softened temperature of the glass preform, the step S3 comprising an annealing procedure to eliminate thermal stress, the step S4 comprising a procedure of eliminating the pressure and then the finished glass and the mold can be separated.

18. The method as claimed in claim 16, wherein a top view of the solid structure glass is polygonal, or round, or elliptic, or sector, or arc, or a free configuration, or a combination thereof.

19. The method as claimed in claim 16, further comprising a step of covering the solid structure glass by a surface film applied for anti-burst, or decoration, or anti-glare, or anti-reflection, or anti-smudge, or hardening, or touch sensing, or the combinations of the afore functions, the surface film being a conductive film or a non-conductive film, the non-conductive film including an anti-burst film, a decoration film, an optical film, an anti-smudge film and a hardening film, the optical film being an anti-glare film or an anti-reflection film.

20. The method as claimed in claim 16, wherein the solid structure glass is applied as cover glasses of display equipments, or outer shells of products, or appearance assemblies of electronic devices, or cover plates of touch devices, or function buttons, or touch panels.
